(19) United States
(12) Patent Application Publication
(10) Pub. No.: US 2007/0078966 A1
(43) Pub. Date: Apr. 5, 2007

(54) Presentation of automation data

(75) Inventor: Clifton H. Bromley, New Westminister (CA)

Correspondence Address: ROCKWELL AUTOMATION, INC./(AT), ATTENTION: SUSAN M. DONAHUE, 1201 SOUTH SECOND STREET, MILWAUKEE, WI, 53204, US

(73) Assignee: Rockwell Automation Technologies, Inc., Mayfield Heights, OH (US)

(21) Appl. No.: 11/239,856

(22) Filed: Sep. 30, 2005

(51) Int. Cl. G06F 15/173

(52) U.S. Cl. 709/224

(57) ABSTRACT

The subject invention pertains to presentation of data. A base presentation can supply coarse data concerning an industrial automation system, for instance. Specific base presentation items can subsequently be identified begetting production of more granular information. In particular, an element can be spawned that provides one or more of text, numbers, graphics, animation, audio and video. The graphical element can remain present and/or active while an item is identified and be removed upon navigation away from the item.

### TECHNICAL FIELD

The subject invention relates generally to industrial automation systems and more particularly toward human machine interfaces (HMIs).

### BACKGROUND

Industrial control systems have enabled modern factories to become partially or completely automated in many circumstances. At the core of the industrial control system, is a logic processor such as a programmable logic controller (PLC). Programmable logic controllers are programmed to operate manufacturing processes via logic programs or routines. These programs are stored in memory and generally executed by the PLC in a sequential manner although instruction jumping, looping and interrupt routines, for example, are also common. Control systems also typically include a plurality of input and output (I/O) modules communicatively coupled to a PLC via a backplane that interface at a device level to switches, contactors, relays, solenoids and sensors, among other devices. Accordingly, such control systems are optimized to control and monitor industrial processes, machines, manufacturing equipment, plants, and the like.

Human machine interfaces (HMIs) or simply user interfaces are important to the successful operation and maintenance of industrial automation devices including both control systems and associated equipment or machinery. User interfaces provide the essential communication link between operators and automation devices. This link allows operators to, among other things, setup and control devices and receive feedback by monitoring device status and health during operation. Without such user interfaces, high-level industrial automation would be difficult if not impossible to achieve.

Over the years, user interfaces have gone through several changes. At first, user interfaces were simply dumb terminals, which merely displayed text messages to end-users indicative of some process performed by a server or processor associated with an automated device. For instance, a failed device would generate an internal error code representing a determined error, which could then be matched to a particular error message and displayed to a user or operator on a display device. Over time, client side processing developed so as to enable a move from a text-based interface to a graphical user interface (GUI). This transition shifted some of the processing burden away from the automated device or associated processor toward the client side GUI. These new GUIs vastly improved the ability of users to access information quickly and easily. Unfortunately, these GUIs were not portable in part because of there size and machine dependencies and therefore not a viable option for managing and controlling a plurality of devices connected together in a network. Shortly thereafter, the processing burden shifted back toward devices and away from interfaces with the advent the Internet and web browsers. As a result, developers began to employ web browsers as interface mechanisms.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Briefly described, systems and methods to facilitate presentation and interaction with automation data are provided. More specifically, mechanisms and methods are presented that supply additional information when desired without requiring navigation to a different presentation display.

In accordance with an aspect of the invention, items or objects in a base presentation are identified. Identification of an item causes a graphical element to be generated and superimposed over the base presentation layer. The graphical element can provide, among other things, additional information regarding the identified item. Information can be provided in a myriad of forms including but not limited to alphanumeric characters, graphics, animations, audio and video. The graphical element can be dismissed, thus returning the display to the original base presentation, upon navigation away from or de-identifying a base presentation item.

In accordance with another aspect of the invention, the graphical elements can be interactive. Graphical elements can provide, request and receive data. For example, graphical elements can enable, among other things, user authentication, change or setting of control values and/or display formats, operation execution, navigation to other presentation displays and/or graphical elements.

In accordance with yet another aspect of the invention, the graphical elements can be dynamically updated. Although the graphical elements can provide static information, they can also provide real-time or dynamically updated information. Accordingly, if information provided by the graphical element changes in a source it will also be changed in the graphical element.

According to still another aspect of the invention, presented data and interaction can be provided based on explicit settings and/or learned based on training or previous interaction. Furthermore, presented data and interaction can be limited or restricted based on user security credentials, among other things.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a block diagram of an interface system in accordance with an aspect of the subject invention.

FIG. 2 is a block diagram of a determination component in accordance with an aspect of the subject invention.

FIG. 3 is a block diagram of a detection component in accordance with an aspect of the subject invention.

FIG. 4 is a block diagram of a resolution component in accordance with an aspect of the subject invention.

FIG. 5 is a block diagram of an element component in accordance with an aspect of the subject invention.

FIG. 6 is a block diagram of an element component including a security component in accordance with an aspect of the subject invention.

FIG. 7 is a block diagram of a security component in accordance with an aspect of the subject invention.

FIG. 8 is a block diagram of an element component including an update component in accordance with an aspect of the subject invention.

FIGS. 9a-9c are exemplary graphical interfaces that depict interaction with a base presentation in accordance with an aspect of the subject invention.

FIG. 10 is a flow chart diagram of an interface interaction methodology in accordance with an aspect of the subject invention.

FIG. 11 is a flow chart diagram of a method of element interaction in accordance with an aspect of the subject invention.

FIG. 12 is a flow chart diagram of a method of interacting with data in accordance with an aspect of the subject invention.

FIG. 13 is a schematic block diagram illustrating a suitable operating environment in accordance with an aspect of the present invention.

FIG. 14 is a schematic block diagram of a sample-computing environment with which the present invention can interact.

### DETAILED DESCRIPTION

The subject invention is now described with reference to the annexed drawings, wherein like numerals refer to like or corresponding elements throughout. It should be understood, however, that the drawings and detailed description thereto are not intended to limit the invention to the particular form disclosed. Rather, the intention is to cover all modifications, equivalents, and alternatives falling within the spirit and scope of the subject invention.

As used in this application, the term “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

Furthermore, the present invention may be implemented as a method, system, apparatus, or article of manufacture using standard programming and/or engineering techniques to produce software, firmware, hardware, or any combination thereof to control a computer or automation device (e.g., controller) to implement the disclosed invention. The term “article of manufacture” as used herein is intended to encompass a computer program accessible from any computer-readable device, carrier, or media. For example, computer readable media can include but is not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, jump drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention.

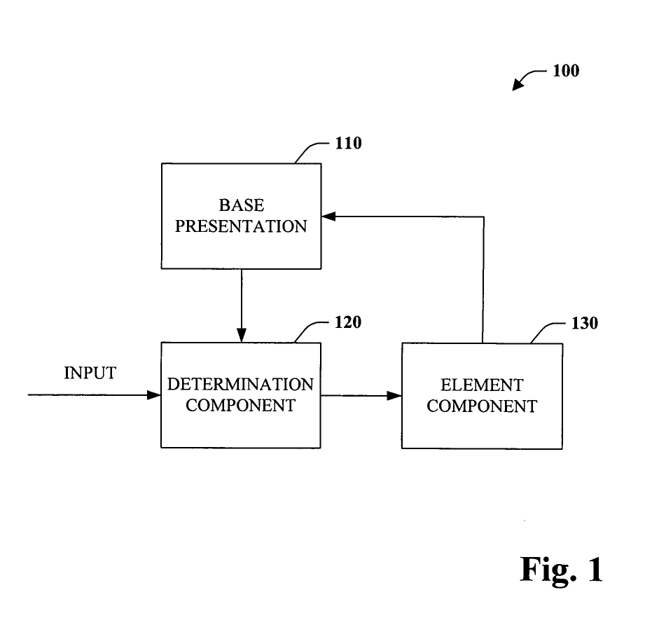

Referring initially to FIG. 1, an interface system 100 is illustrated in accordance with an aspect of the subject invention. System 100 includes base presentation 110, determination component 120 and an element component 130. Base presentation 110 includes a graphical representation of one or more items (also referred to herein as objects). The base presentation can be displayed or otherwise presented or provided via a display such as a human machine interface and associated equipment. The graphical presentation can include separate images for one or more items or alternatively multiple items can be part of a larger image map, among other things. In accordance with an aspect of the subject invention, the items presented can correspond to graphical representations of automation devices.

Automation devices can include any one of a plurality of industrial processes and machines including but not limited to programmable logic controllers (PLCs), pumps providing fluid transport and other processes, fans, conveyor systems, compressors, gearboxes, motion control and detection devices, sensors, screw pumps, and mixers, as well as hydraulic and pneumatic machines driven by motors. Such motors can be combined with other components, such as valves, pumps, furnaces, heaters, chillers, conveyor rollers, fans, compressors, gearboxes, and the like, as well as with appropriate motor drives to form industrial machines and actuators. For example, an electric motor could be combined with a motor drive providing variable electrical power to the motor, as well as with a pump, whereby the motor rotates the pump shaft to create a controllable pumping system. Accordingly, the term automation device refers to control systems (e.g., PLCs) and components thereof (e.g., modules) as well as the equipment, machines and/or systems with which they interact.

Determination component 120 can determine whether an item is identified. Determination component 120 receives, retrieves or otherwise obtains the base presentation or a representation thereof, for example from an interface system proximate or remote from automation devices. Additionally, determination component 120 can optionally receive an input. The input can correspond to navigational input, among other things, such as the movement and location of a mouse, stylus, or other pointing device. It should also be appreciated that the input could be an event (e.g., an error, warning, alarm . . . ) originating with a control system condition related to an item represented on the base presentation. In any case, determination component 120 can determine whether an item is identified based on the base presentation and the input. Upon determination that an item has been identified, determination component 120 can output the identity of the item. Determination component 120 can also determine if and when an identified item is no longer identified and generate and indication thereof.

Element component 130 is communicatively coupled to determination component 120. Upon receipt of the identity of an item, amongst other information (e.g., location of interface relative to devices), element component 130 can modify the base presentation. For example, element component could overlay or superimpose a graphical element on the base presentation. The graphical element can take many forms including but not limited to a bubble or a box (e.g., text box, dialog box . . . ). In accordance with an aspect of the invention, this graphical element can be situated in close proximity to an identified item and provide additional information about the identified item. Thus, the graphical element can correspond to a tool tip, but is not limited thereto. The information provided by the graphical element can be in the form of one or more of text, numbers, graphics, animations, audio, and video, inter alia. Furthermore, it should be appreciated that the modification to the base presentation need not be graphical. It could simply be the addition of audio, for instance. The modification of the base presentation can remain in effect while an item is identified. The addition(s) can be removed and the base presentation restored by element component 130 upon receipt of a signal from determination component that the previous item is no longer identified.

It should also be noted and appreciated that determination component 120 can determine identification of modification to the base presentation such as a graphical element, or portions thereof, generated by element component 130. In one exemplary scenario, a first element in the base presentation can be identified and a graphical element produced in response to the identification. This graphical element could provide additional information concerning the identified item. Subsequently, the graphical element or part of the element such as a graphic or text can be identified and a second graphical element produced as a consequence. This second graphical element can provide further information about the identified graphic. The graphical elements could be dismissed, among other things, upon navigation away from identified items.

The subject invention as claimed has numerous advantages. One advantage that can be gleaned from the description thus far is that the subject invention provides a mechanism for providing additional or less important information if and when needed without requiring navigation to a different presentation display. Further, such mechanism reduces information clutter that can obscure or completely replace the base presentation by providing additional information upon identification and dismissal of such information upon de-identification.

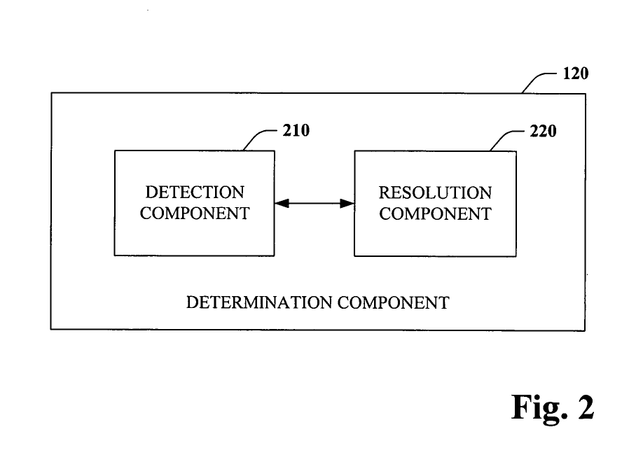

Turning briefly to FIG. 2, a determination component 120 is illustrated in accordance with an aspect of the invention. As described supra, determination component 120 can determine identification of items. Determination component 120 can include detection component 210 and resolution component 220. Detection component 210 enables determining identification through detection. Thus, an explicit identification of an item can be detected by detection component 210. Resolution component 220 aids the same determination via resolution. As will be described in later sections, resolution component 220 can resolve or determine identification of an item automatically without explicit identification of items. Furthermore, resolution component 220 can be communicatively coupled to the detection component. Data can be received, retrieved or otherwise acquired by resolution component 220 from detection component 210 to assist in automatic identification of items.

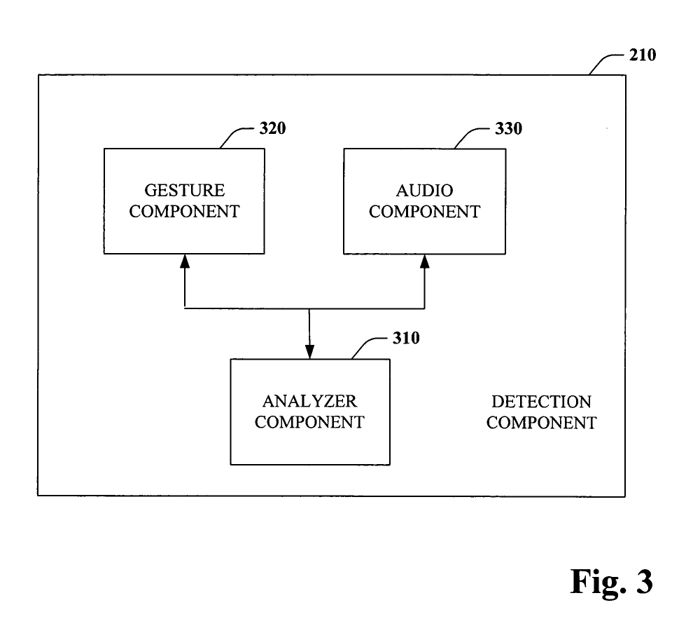

FIG. 3 depicts a detection component 210 in accordance with an aspect of the subject invention. Detection component 210 includes analyzer component 310. Analyzer component 310 utilizes algorithms to analyze input from one or more sources and employs the data received or retrieved to detect when an item on a base presentation is explicitly identified. Analyzer component 310 can receive input from gesture component 320, audio component 330 and/or various subcomponents thereof Gesture component 320 can recognize and monitor user body movements and communicate this information to the analyzer component 310. In a simple example, a gesture could be monitored by movement of a mouse, stylus or the like (e.g., depression of keyboard keys . . . ). However, gesture component 320 can also employ, or be communicatively coupled to, sensors, cameras, infrared transmitters or the like to facilitate recognition of hand movements (e.g., finger pointing, sign language . . . ), facial expressions and/or vision gaze. For example, gesture component 320 can provide analyzer component 310 information pertaining to an item or area based on user pointing or gaze direction. Detection component 210 can also include an audio component 330 that can monitor and recognize sounds such as the voice of a user. This audio information can also be provided to analyzer component 310 to facilitate detecting whether an item is being identified. As mentioned previously, analyzer component 310 can utilize information from multiple sources. For instance, analyzer component 310 can detect that an item is being identified based on a user pointing as well as verbalizing the name of an item.

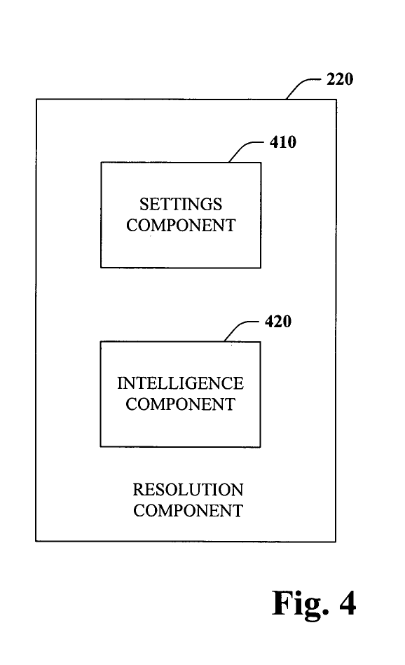

FIG. 4 illustrates a resolution component 220. An item need not be explicitly identified. Resolution component 220 can determine whether to indicate that an item is being identified. Resolution component 220 includes both a settings component 410 and an intelligence component 420.

Settings component 410 can retrieve user settings regarding identified items. For example, a user can specify, for a base presentation, that they would like to view more detailed information regarding item A, followed by item B and terminating with item C. The settings may also specify a time period associated with each. Accordingly, settings component 410 can review the settings and indicate that item A is selected for five seconds, followed by item B for ten seconds, and then item C for five seconds.

Intelligence component 420 can infer (as that term is defined herein) and automatically select items of interest for a period of time. Intelligence component 420 can infer that a user would desire to view additional information about an item in the base presentation based on past interaction as well as context. Accordingly, intelligence component 420 can employ artificial intelligence (e.g., support vector machines, neural networks, Bayesian belief networks, fuzzy logic . . . ) and/or rule based (e.g., expert systems, knowledge based systems . . . ) methods or mechanisms that resolve whether an item(s) should be designated as identified and facilitate machine learning. By way of example, based on previous interactions (from detection component) intelligence component 420 can determine or learn that a user typically identifies item A for five seconds and item B for ten seconds. Accordingly, on display of the base presentation item A can be identified as being selected followed by item B. Intelligence component 410 may also, sua sponte, set item C as being selected based on context, such as a malfunction or potentially dangerous operation, or upcoming event (e.g., scheduled or periodic maintenance, among other things.

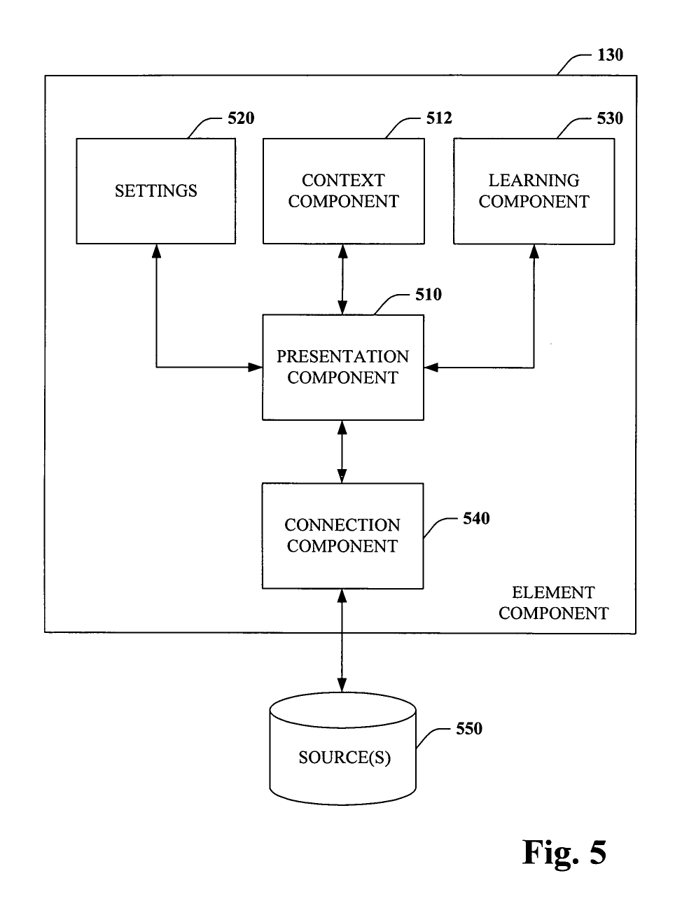

Referring to FIG. 5, an element component 130 is depicted in accordance with an aspect of the subject invention. As previously described, element component 130 can generate an addition to the base presentation such as text, numbers, graphics, animations, sound, and/or video for items upon identification. This addition can provide supplemental or more granular information regarding an item than is provided by the base presentation. Element component 130 can include a presentation component 510 that controls generation and interaction with the added element. Settings 520 and learning component 530 can assist presentation component 510 in determining what data to display, the format thereof, and the type of interaction allowed, among other things. Furthermore, context component 512 can determine and provide context information to the presentation component 510.

Settings 520 are explicitly defined instructions or rules, for example determined by a system designer pertaining to what data is provided, how it is provided, to whom such data is supplied, and whether or the type of interaction allowed. In essence, rules can be defined based upon, inter alia, role and context or situational awareness. As per role, particular data can be designated for presentation based on a user role and/or position. For example, if it is known, that a user is a machine operator, it can be defined that current operating parameters of an automation device such as a pump (e.g., on/off, flow rate, operational alarms . . . ) be presented or displayed first. Alternatively, if the role corresponds to maintenance engineer, information regarding when the pump was last serviced and characteristics such as vibration, can be provided that indicate whether a device needs to be serviced or replaced. Rules or instructions can also be specified with respect to context or situational awareness. Context information can be supplied from outside the element component 130 or determined and provided by context component 512 within the element component 103 which communicates with presentation component such information to presentation component 510. By way of example and not limitation, rules may be defined relative to the physical location to an automation device. Location of an interface relative to an identified device is context information that can be determined and supplied by context component 512. Interaction at a location proximate to a device may present different information and allow initiation of disparate actions than if the user was at a remote location. For instance, for safety purposes a user could be prevented from operating a five ton punch press remotely via a laptop and web browser even though that same user would be able to do so if they were next to the machine. Therefore, location of a user may change the data presented and how a user can interact therewith.

In addition to data provided by the element, the presentation component 510 can control the format thereof, for example, based on context and/or settings. For instance, the settings and/or context could influence graphical element color and measure system such as whether temperature is provided in degrees Celsius, Fahrenheit, or both.

The settings 520 may first be set by designers, but users may modify some settings. For example, users can indicate through interaction that certain data be shown to them again, that particular data not be provided again, or a particular order of presentation. Users may also modify settings regarding format of data presentation. However, there may be some settings that are not modifiable for safety or security reasons.

The element component 130 can also include a learning component 530 communicatively coupled to the presentation component 510. Similar to settings 520, the learning component 530 can provide information (e.g., based on context . . . ) to the presentation component to facilitated appropriate format and presentation. By contrast, learning component 520 can learn or infer (as that term is defined herein) on a user-by-user basis what information or interactive capabilities are desired as well as the order and format of the presentation, among other things. Based on training or previous interaction, learning component 530 can learn what a particular person wants to know about an automation device, for example, rather than presenting information based on settings 520.

Connection component 540 is communicatively coupled to presentation component 510. Connection component 540 facilitates interaction with one or more sources 550 or data sources. In one instance, presentation component 510 can determine that it will need to provide particular information located in a source. Presentation component 510 can identify the source and provide the identity to connection component 540. Upon receipt of a request, connection component 550 can set up the data source connections necessary to supply data to the presentation component 510. The data sources can provide static data (e.g., configuration data), historical data, reporting service data, and/or live or real time data, among other types and forms of data.

It should also be appreciated that the element provided by presentation component 510 can be interactive. Accordingly, it may receive data that is to be stored. Received data can be written to a source via connection component 540. The received data can also be utilized to alter settings or presentation formats, inter alia. Still further yet it should be noted that element component 130, and more specifically presentation component 510, can facilitate navigation to other presentation displays and/or elements, among other things.

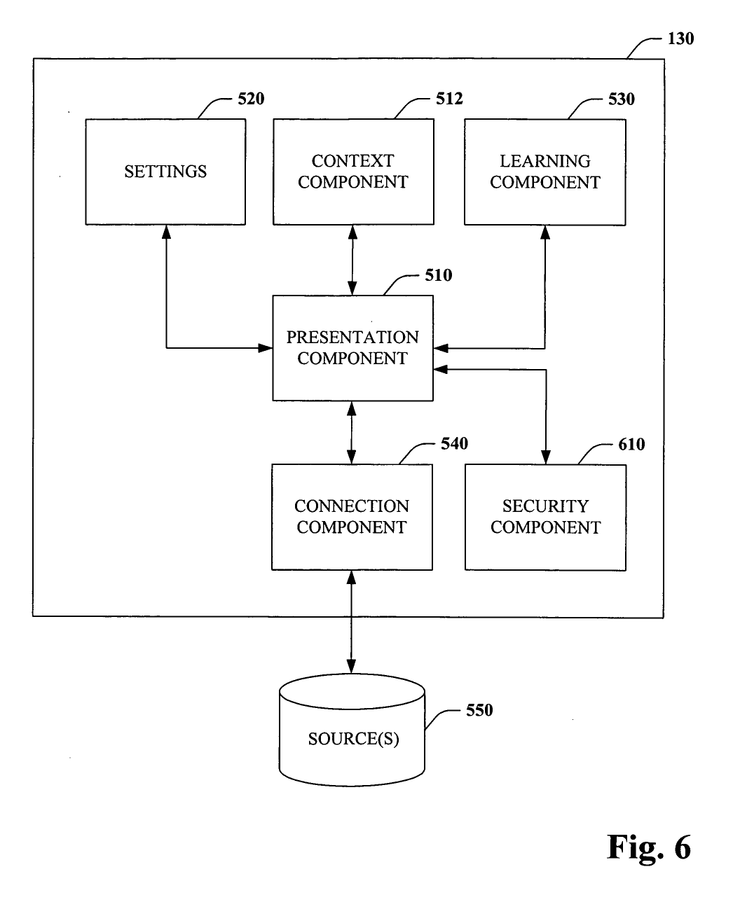

FIG. 6 is a block diagram of an element component 130 in accordance with an aspect of the subject invention. Similar to FIG. 5, element component 130 can include a presentation component 510. The presentation component 510 can generate and control interaction with one or more elements added to a base presentation. Settings 520 and learning component 530 can be utilized to influence the format as well as the data provided by an element, for example based on context information provided by context component 512. Connection component 540 is communicatively coupled to presentation component 510 and one or more sources 550 and is operable to establish a connection between the presentation component 510 and one or more data sources 550. Element component 130 also includes a security component 610. Security component 610 is communicatively coupled to presentation component 510 and facilitates control of data presented by and/or interaction with elements. Accordingly, a mechanism is provided to ensure that at least some data is presented only to authorized users. By way of example, component 610 can provide security credentials for a user to the presentation component 510. The presentation component 510 can then present data and/or allow interaction that is appropriate for a security level of a user, an associated group or role. For example, security credentials can be provided based on training and/or certifications such that some operators may be able view parameters but not change them while others may be able to view and change or not view and not change. The identity of the user could come from outside the system of the subject invention such as from a computer or program login or the like. Alternatively, an element could request and receive information to enable a determination of a user's identity, for instance utilizing the security component 610. For example, a graphical element could request a username and password, or a user may be asked to touch or gaze at the element to facilitate biometric identification.

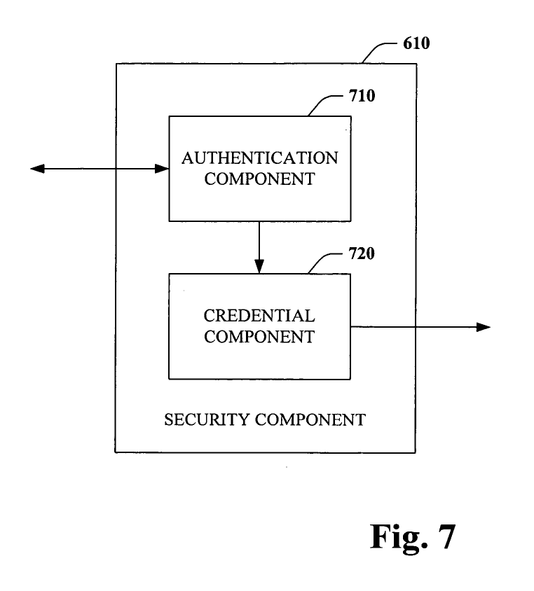

FIG. 7 depicts a security component 610 in accordance with an aspect of the subject invention. Security component 610 can include an authentication component 710 and a credential component 820. Authentication component 710 determines the identity of a user. For example, a user may be asked to furnish a user name and password. Authentication can also be accomplished by receiving a smart card to identify the user. Still further yet, authentication component 710 can employ biometric authentication. Biometric authentication utilizes physical characteristic unique to individuals. For example, biometric authentication can include but is not limited to identifying a user via fingerprint, palm geometry, retina, facial features (e.g., 2-D, 3-D . . . ), signature, typing pattern (e.g., speed, rhythm . . . ), and/or voice recognition, among others. Authentication component 710 provides the credential component 720 with the identity of the user. The credential component 720 matches the user with particular credentials based on the individual user, group membership, and/or role (e.g., position, administrator, manager, operator, engineer . . . ), inter alia. The credentials specify the type, class and/or category of information that a user can obtain, or alternatively is prohibited from receiving.

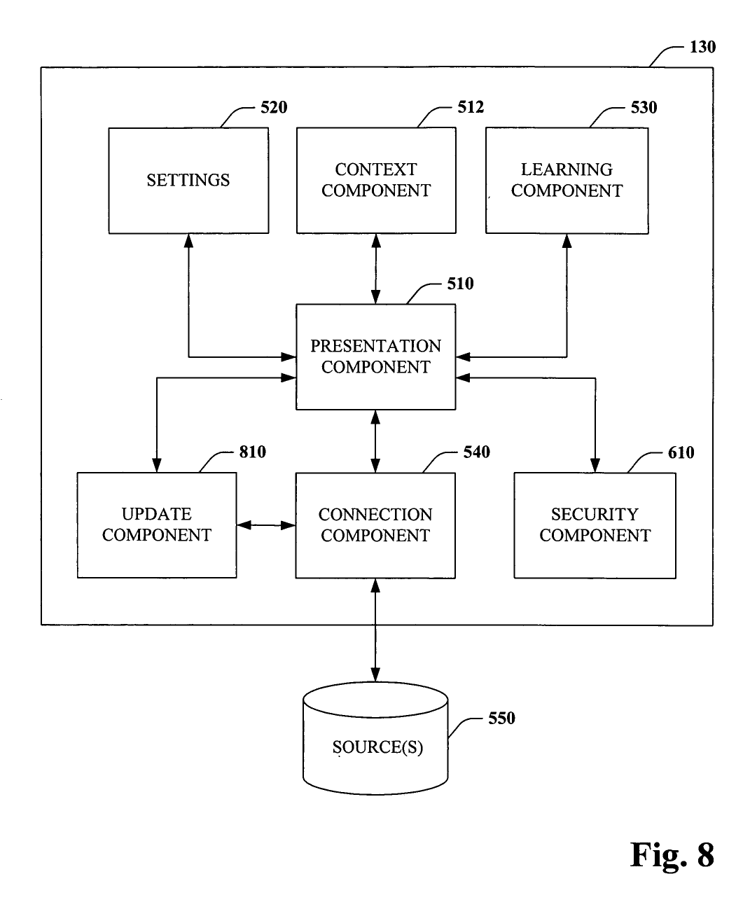

Turning to FIG. 8, an element component 130 is illustrated in accordance with an aspect of the subject invention. Similar to FIG. 6, element component 130 includes a presentation component 510 that produces and manages interaction with an element provided on a base display. The format of the element including the data to be supplied therewith can be influenced by settings 520 and/or learning component 530 as well as context component 512. Additionally, connection component 540 is provided to set-up connections to one or more sources 550 necessary to supply data to the element. Still further yet, security component 610 is provided to facilitate user identification to facilitate limiting presentation and/or interaction based on security credentials. Element component 130 can also include an update component 810. Update component 810 can monitor one or more sources and detect changes to particular data being utilized by the presentation component 510 for an element. Hence, update component 810 can be communicatively coupled to presentation component 510 and connection component 540. Update component 810 can receive, retrieve, or otherwise obtain the location and identity of data of interest from the presentation component 510. Update component 810 can then monitor the particular source. If a change is detected update component 810 can inform presentation component 510. Subsequently, update component 810 can provide presentation component 510 with the updated data or presentation component 510 can retrieve the data itself via connection component 540. The new data can then by provided for presentation by an element. It should also be appreciated that this type of polling methodology can be executed by a source 550, for example utilizing a servlet or service, thereby eliminating the need for the update component 810 in certain instances.

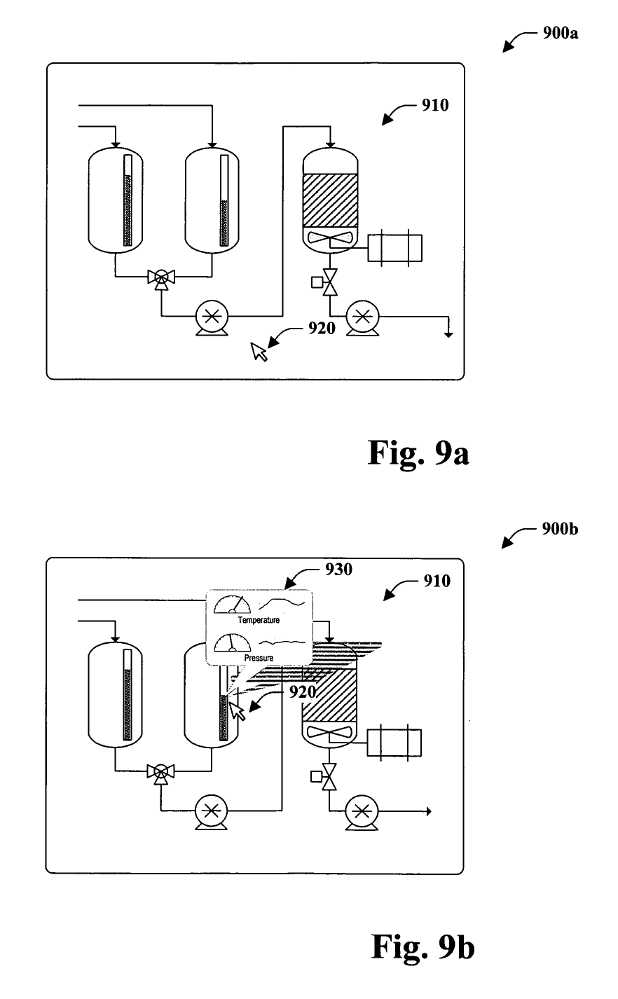

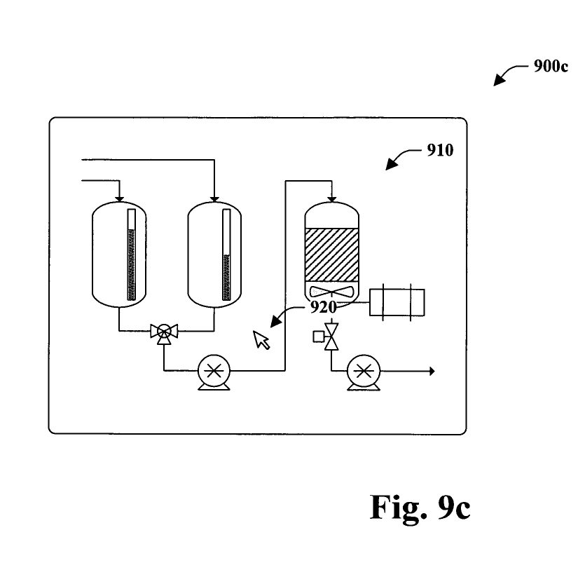

FIGS. 9a-9c illustrate exemplary graphical interfaces 900a, 900b, and 900c. Together the interfaces depict interaction with a base presentation to facilitate clarity and understanding with respect to aspects of the subject invention. It should be noted that these illustrations are provided by way of example and not limitation. As one of skill in the art can appreciate, there is a myriad of ways to arrange and present items on graphical interfaces. The depicted interfaces illustrate only one such arrangement and are not meant to limit the scope of the subject invention to that which is disclosed.

FIG. 9a is an exemplary interface 900a with base presentation 910. The base presentation includes graphical representations of two tanks connected to a valve connected to a pump, a mixer to mix the material provided by the tanks, a motor to power the mixer, another valve and another pump. The tanks have bars on them to indicate pressure within the tanks. Accordingly, the base presentation provides a degree of information concerning a system. The arrow or cursor 920 can be positioned within the base presentation in response to a gesture, voice command, or the like.

FIG. 9b illustrates an exemplary interface 900b with base presentation 910. The base presentation is the same as that of FIG. 9a. Here, however, arrow or cursor 920 has been positioned with respect to the second of two tanks. If the arrow is positioned there for a predetermined amount of time, item identification has been detected. In response, a graphical element 930 is rendered and superimposed on the base presentation 910. Graphical element includes a gage and chart with respect to temperature and pressure, which is more granular than the data provided by the base presentation 910. Graphical element 930 remains visible and dynamically updating (and interactive where appropriate) as long as the base presentation item or object remains identified, for example while the user hovers a mouse pointer over it. FIG. 9c depicts an interface 900c where the tank is no longer identified or de-selected. Here, the mouse pointer has been moved off the previously identified tank object. As a result, the graphical element is removed.

The aforementioned systems have been described with respect to the interaction between several components and/or systems. It should be appreciated that such systems can include those components and/or systems specified therein, some of the specified components, and/or additional components specified in other systems. By way of example and not limitation, element component 130 can include settings component 520, learning component 530, context component 512, security component 610, and update component 810 or any combination thereof. In particular, context and security information can be provided from outside element component 130 thereby eliminating the need for context component 512 and security component 610. Additionally, it should be noted that one or more components may be combined into a single component to provide aggregate functionality or divided into several subcomponents. For instance, detection component 210 can include gesture sub-component 320 and audio sub-component 330 or alternatively be communicatively coupled to such components outside the detection component 210. The components may also interact or be integrated with one or more other components or systems not specifically described herein for purposes of brevity but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). This includes but is not limited to components previously described with such functionality, for example intelligence component 420 and learning component 530. Such components, inter alia, can automate certain mechanisms or processes performed thereby to make portions of the systems and methods more adaptive as well as efficient and intelligent.

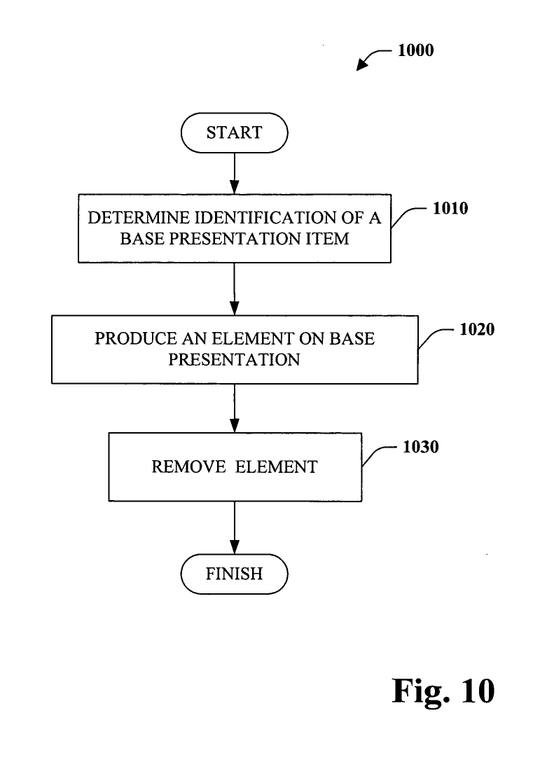

In view of the exemplary systems described supra, methodologies that may be implemented in accordance with the present invention will be better appreciated with reference to the flow charts of FIGS. 10-12. While for purposes of simplicity of explanation, the methodologies are shown and described as a series of blocks, it is to be understood and appreciated that the subject invention is not limited by the order of the blocks, as some blocks may occur in different orders and/or concurrently with other blocks from what is depicted and described herein. Moreover, not all illustrated blocks may be required to implement the methodologies in accordance with the subject invention.

Additionally, it should be further appreciated that the methodologies disclosed hereinafter and throughout this specification are capable of being stored on an article of manufacture to facilitate transporting and transferring such methodologies to computers. The term article of manufacture, as defined supra, is intended to encompass a computer program accessible from any computer-readable device, carrier, or media.

FIG. 10 depicts an interface interaction methodology 1000 in accordance with an aspect of the subject invention. At reference numeral 1010, identification of a base presentation item is determined. This determination can be made in a number of ways including detecting gestures toward a particular graphical item or object. For example, an item can be identified by hovering a cursor over the item for a predetermined time or by depression of a combination of keyboard keys. Furthermore, the determination can be automatic based on past interaction and/or predefined settings. At 1020, an element is produced and superimposed on the base presentation. The element can be a graphical element such as but not limited to a bubble, box, or tool tip. The graphical element can include at least one of text, numbers, graphics, animations, sound, and video. In accordance with an aspect of the invention, the element can provide additional or more granular information pertaining to an identified item then is provided by the base presentation. At reference number 1030, the element can be removed. Removal of the element can be engendered by de-identification or de-selection of a base presentation item.

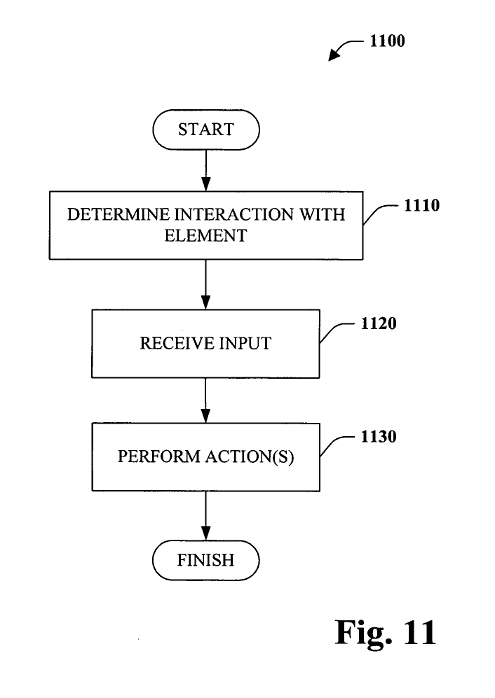

FIG. 11 illustrates a method 1100 of element interaction in accordance with an aspect of the subject invention. An element, such as a graphical element, that overlays a base presentation is not restricted to simply providing information. The element can also be interactive. At reference numeral 1110, interaction with an element is determined. For example, it can be determined that an individual is navigating within a presented graphical element. At 1120, input can be received. Input can be received by a myriad of mechanisms including but not limited to determining identification of an item or object within the element, depression of one or more keys on a keyboard, clicking, touching and other selection mechanisms. At reference numeral 1130, one or more actions are performed in response to the input. For example, if it is determined that an object-or item in an element is identified and additional element can be generated and superimposed on the base presentation. In another exemplary scenario, input can correspond to clicking or otherwise selecting a link and the response can be generation or navigation to another base presentation display. Still further yet an operation can be executed such as turning on a automation device such as a motor or converting from Celsius to Fahrenheit or vice versa.

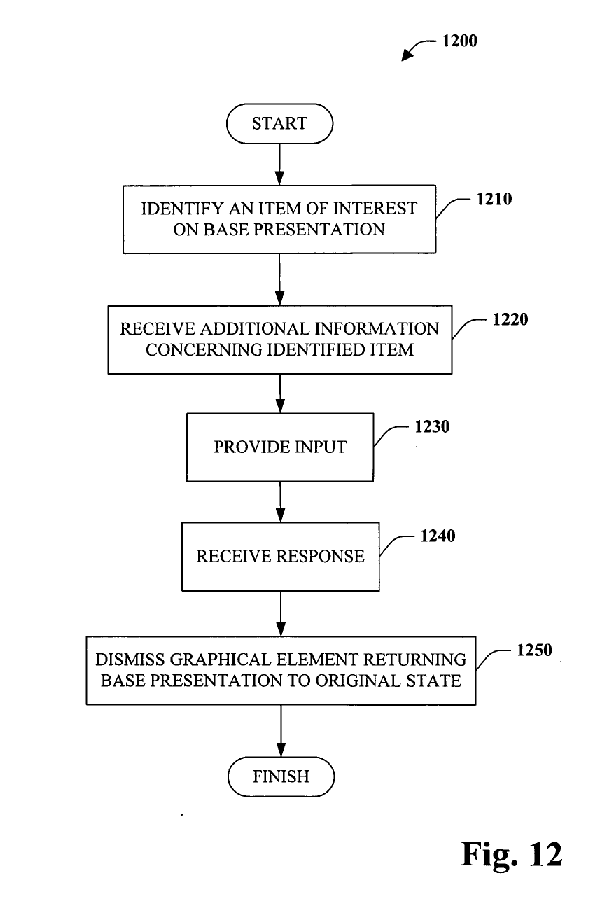

FIG. 12 depicts a method of interacting with an interface in accordance with an aspect of the subject invention. At reference numeral 1210, an item or object of interest on a base presentation display is identified. An item can be identified in a variety of manners including but not limited to gesturing such as via positioning and hovering of a cursor, pointing, and/or gazing as well as verbalizing the name of a particular item. At 1220, additional information is received pertaining to the identified item. This information can be presented via a graphical element proximate to the identified item, which includes one or more of text, numbers, graphics, animations, audio and video. At 1230, input can be provided through the graphical element. Input can include but is not limited authentication data (e.g., user name, password, biometric data . . . ), automation device data, display format data, item identification or selection, and operation specification. At 1240, a response can be received to the input. For example, the response can be a message indicating data has been updated, access has been denied and/or granted, a sound effect, another element, a new base presentation and/or the like. Thus, acts 1230 and 1240 can correspond to interaction with an element. At reference numeral 1250, the graphical element can be dismissed. This can be accomplished by navigation away from the identified item. Dismissal of the graphical element can result in a restoring the base presentation to its original state where it is modified to facilitate presentation of an element.

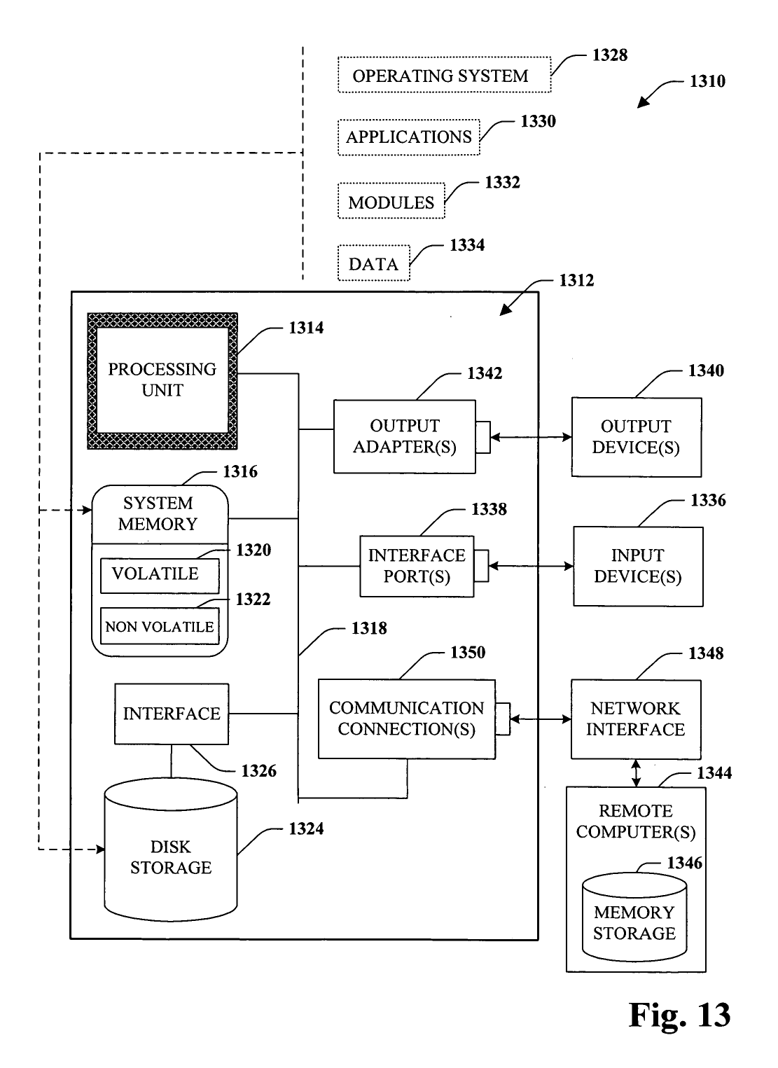

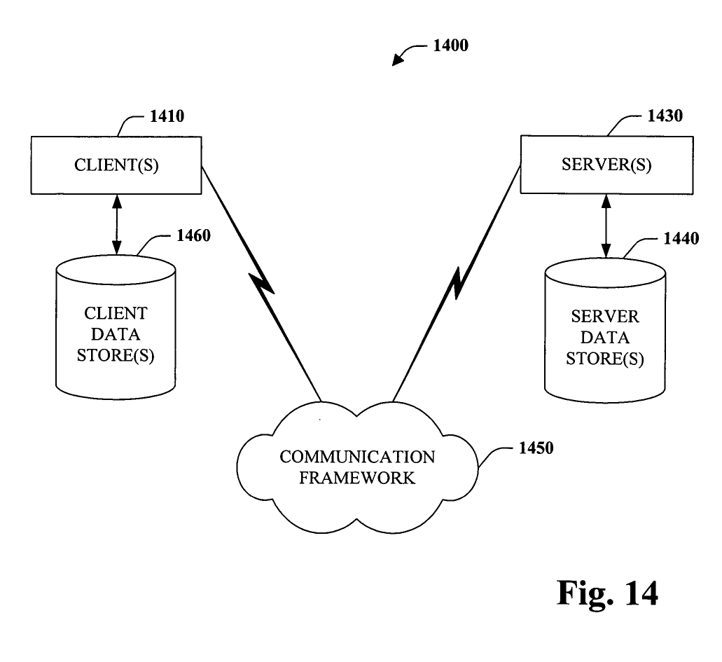

In order to provide a context for the various aspects of the invention, FIGS. 13 and 14 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, industrial controllers, and the like. The illustrated aspects of the invention may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 13, an exemplary environment 1310 for implementing various aspects of the invention includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable ROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/non-removable, volatile/non-volatile computer storage media. FIG. 13 illustrates, for example disk storage 1324. Disk storage 4124 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the present invention can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312 and to output information from computer 1312 to an output device 1340. Output adapter 1342 is provided to illustrate that there are some output devices 1340 like displays (e.g., flat panel and CRT), speakers, and printers, among other output devices 1340, that require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems, power modems and DSL modems, ISDN adapters, and Ethernet cards.

FIG. 14 is a schematic block diagram of a sample-computing environment 1400 with which the present invention can interact. The system 1400 includes one or more client(s) 1410. The client(s) 1410 can be hardware and/or software (e.g., threads, processes, computing devices). The system 1400 also includes one or more server(s) 1430. The server(s) 1430 can also be hardware and/or software (e.g., threads, processes, computing devices). The server(s) 1430 can house threads to perform transformations by employing the present invention, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the terms “includes,” “has,” and “having” are variations in form thereof are used in either the detailed description or the claims, such term is intended to be inclusive in a manner similar to the term “comprising” as “comprising” is interpreted when employed as a transitional word in a claim.

What is claimed is:

1. A human machine interface system comprising the following computer executable components:
a determination component that determines identification of a graphic representation of an automation device on a base presentation; and
an element component that provides a graphical element that overlays the base presentation upon and only during identification of an automation device.

2. The system of claim 1, the determination component includes a detection component that detects identification of an automation device based at least upon the base presentation and navigation input.

3. The system of claim 2, the navigation input is provided by positional and temporal data associated with a cursor.

4. The system of claim 2, the navigation input is audible.

5. The system of claim 2, the determination component includes a resolution component that determines identification of a graphic representation based upon one of previous interaction and predefined settings.

6. The system of claim 1, the graphical element is one of a tool tip and dialog box.

7. The system of claim 1, the element component includes a presentation component that determines data to be presented based at least on the identified automation device.

8. The system of claim 7, the presentation component determines data to be presented, format of presentation and/or interaction allowed for the graphical element based on predefined settings.

9. The system of claim 7, further comprising a learning component that infers data to be presented, format of presentation and/or interaction allowed for a graphical element based on training or previous interaction.

10. The system of claim 7, further comprising a connection component that connects to one or more data sources and provides data for presentation by the graphical element including one or more of text, numbers, graphics, animation, audio, and video.

11. The system of claim 7, further comprising an update component that monitors one or more sources via the connection component, detects change, provides changed data for presentation to support real-time presentation.

12. The system of claim 7, further comprising a security component that facilitates restriction of information presented or interaction allowed via the element based on individual or associated group credentials and/or security status.

13. The system of claim 7, further comprising a context component that provides context or situation awareness information to the presentation component to facilitate a determination of data to be presented, format of presentation and/or interaction allowed.

14. The system of claim 7, the presentation component receives input provided via the graphical element.

15. A human machine interface system comprising:
a means for determining identification of a graphical representation of an automation device in a base presentation; and
a means for generating and superimposing a graphical element that provides information concerning the automation device on the base presentation only while the device remains identified.

16. The system of claim 15, the graphical element provides information via one or more of text, numbers, graphics, animation, audio, and video.

17. The system of claim 15, further comprising a means for receiving data via the graphical element and providing the data to a source.

18. The system of claim 15, further comprising a means to facilitate restricting information provided by the graphical element based on security credentials of a user.

19. The system of claim 15, further comprising a means for navigating to another graphical element or presentation display.

20. A method of interacting with industrial automation device data comprising:
determining identification of a graphical representation of an automation device on a graphical display; and
rendering a first graphical element superimposed on the display, the graphical element providing information of interest pertaining to the identified device.

21. The method of claim 20, further comprising determining display format from one of preconfigured settings and context.

22. The method of claim 20, further comprising connecting to a data source to supply information to the graphical element.

23. The method of claim 22, further comprising updating the data source in response to interactions with the graphical element.

24. The method of claim 20, further comprising updating the data presented by the graphical element upon change of the data.

25. The method of claim 20, further comprising updating the data presented by the graphical element upon interaction with the graphical element.

26. The method of claim 20, further comprising identifying a user and providing data authorized for presentation to the user via the graphical element and/or enabling or disabling interaction.

27. The method of claim 20, removing the first graphical element thereby restoring the original graphical display upon detecting navigation away from the identified representation of an automation device.

28. The method of claim 20, further comprising rendering a second graphical element upon detecting identification of data provided in the first graphical element.

29. The method of claim 28, determining identification of data provided in the first graphical element comprises detecting a gesture directed toward an item in the first graphical element.

30. The method of claim 29, the gesture includes positioning a cursor on or over the first graphical element item.

31. The method of claim 29, removing the second graphical element upon detecting navigation away from one of the second graphical element and the identified representation of an automation device.

32. The method of claim 20, detecting identification of a graphical representation of an automation device on a graphical display comprises detecting hovering of a cursor over the graphical representation.

33. The method of claim 20, the first graphical element is superimposed in close proximity to the identified representation of an automation device.

34. A computer readable medium having stored thereon computer executable instructions for carrying out the method of claim 20.
